(19) United States
(12) Patent Application Publication
(10) Pub. No.: US 2011/0242807 A1
(43) Pub. Date: Oct. 6, 2011

(54) LIGHT COVER AND ILLUMINATING APPARATUS APPLYING THE SAME

(75) Inventors: William D. Little, JR., Corinth, TX (US); Yu-Ju Liu, Taipei (TW); Kuan-Hung Chen, Taipei (TW)

(73) Assignees: APHOS LIGHTING LLC, Carrollton, TX (US); EVERLIGHT ELECTRONICS CO., LTD., Taipei (TW)

(21) Appl. No.: 12/752,090

(22) Filed: Mar. 31, 2010

(51) Int. Cl. F21V 5/00

(52) U.S. Cl. 362/235; 362/326

(57) ABSTRACT

A light cover and an illuminating apparatus applying the same are provided. The illuminating apparatus comprises the light cover and a plurality of light sources. The light cover comprises a substrate provided with a plurality of recesses on a front surface and a plurality of lenses integrated with the substrate and respectively located in the recesses. The lenses are oriented in a same direction. The light sources are disposed corresponding to the lenses. Each of the light sources is adapted to emit a light. Each of the lenses is adapted to receive the light and transform the light into a predefined light output.

### BACKGROUND OF THE INVENTION

1. Field of the Invention

The present invention generally relates to an illuminating apparatus; and more particularly, to an illuminating apparatus for providing a specific profile of light output complying with various illuminating requirements.

2. Description of Related Art

Light emitting diodes (LEDs) have replaced fluorescent lamps and incandescent lamps in some fields, for example, lamps of scanners requiring for quick response, lamps of projection apparatus, backlight sources or front light sources of liquid crystal displays (LCDs), illumination for dashboards of automobiles, traffic lights, street lights, common illumination devices, etc. Compared with conventional lamps, the LEDs have absolute advantages, for example, small volume, long lifespan, low driving voltage/current, being non-fragile, mercury free (no pollution), and good luminous efficiency (power saving).

Since light emitting of an LED is omni-directional, front light emitting amount of the LED is limited. When applying the LED as a light source, the application and the availability of an illuminating apparatus is restricted in different illuminating circumstances.

### SUMMARY OF THE INVENTION

Accordingly, the present invention is directed to an illuminating apparatus capable of meeting various illuminating requirements and achieving high availability in using.

The present invention is also directed to a light cover applied in the aforementioned illuminating apparatus.

As embodied and broadly described herein, the present invention provides an illuminating apparatus comprising a light cover and a plurality of light sources. The light cover comprises a substrate provided with a plurality of recesses on a front surface and a plurality of lenses integrated with the substrate and respectively located in the recesses. The lenses are oriented in a same direction. The light sources are disposed corresponding to the lenses. Each of the light sources is adapted to emit a light. Each of the lenses is adapted to receive the light and transform the light into a predefined light output.

Accordingly, the illuminating apparatus adopts the lenses to receive light emitted from the light sources and transform the lights in to a predefined light output. Specific profiles of light output can be obtained to meet various illuminating requirements and the availability of the illuminating apparatus can therefore be improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a light cover according to an embodiment of the present invention.

FIG. 2 is a front view of the light cover of FIG. 1.

FIG. 3 show a profile of the light cover along a cross-section A-A′ in FIG. 2.

FIG. 4 shows another profile of the light cover along a cross-section B-B′ in FIG. 2.

FIG. 5 is a side view of an illuminating apparatus accompanied with an enlarged cross-sectional view of the asymmetric lens in FIG. 4 according to an embodiment of the present invention.

FIG. 6 shows a streetlamp applying the illuminating apparatus in FIG. 5 according to an embodiment of the present invention.

FIG. 7 illustrates a light cover according to another embodiment of the present invention.

FIG. 8 is a front view of the light cover of FIG. 7.

FIG. 9 show a profile of the light cover along a cross-section C-C′ in FIG. 8.

FIG. 10 shows another profile of the light cover along a cross-section D-D′ in FIG. 8.

FIG. 11 is a side view of an illuminating apparatus accompanied with an enlarged cross-sectional view of the asymmetric lens in FIG. 9 according to an embodiment of the present invention.

FIG. 12 shows a streetlamp applying the illuminating apparatus in FIG. 11 according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

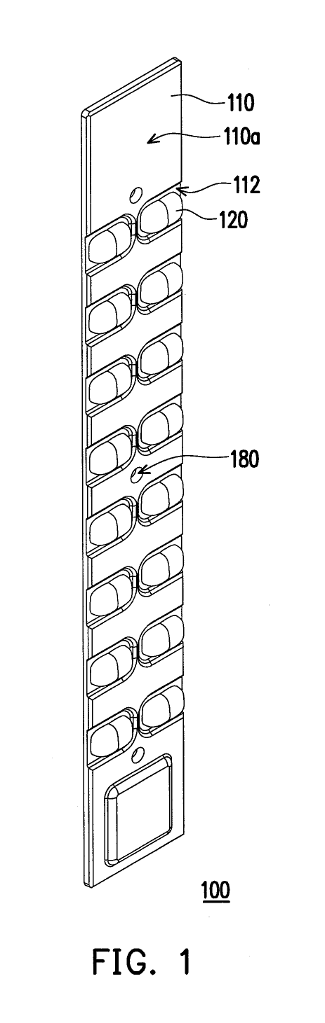

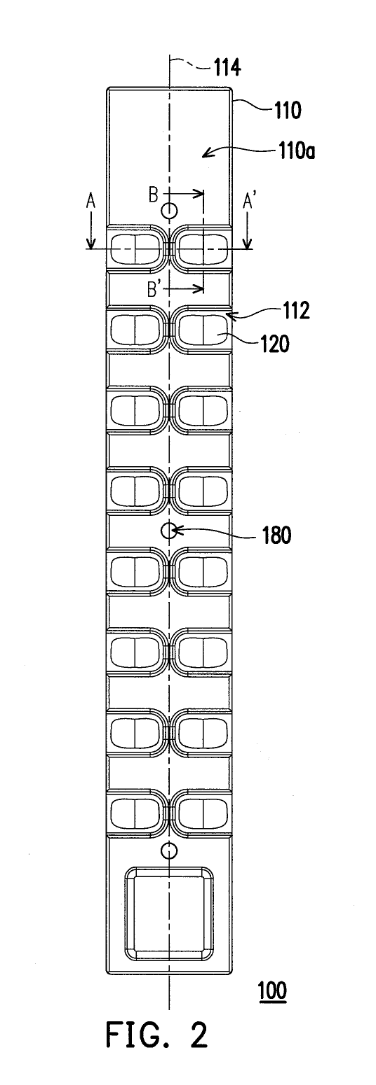

FIG. 1 illustrates a light cover according to an embodiment of the present invention. FIG. 2 is a front view of the light cover of FIG. 1. Referring to FIGS. 1 and 2, the light cover 100 comprises a substrate 110 and a plurality of asymmetric lenses 120. The substrate 110 has a plurality of recesses 112 on a front surface 110a. The asymmetric lenses 120 are integrated with the substrate 110 and respectively located in the recesses 112. Herein, the asymmetric lenses 120 may be arranged in an array or in any probable arrangement. Moreover, the asymmetric lenses 120 and the substrate 110 may be integrally formed as one piece by molding process. The front surface 110a of the substrate 110 may be a rough surface, or a connected material of another color, so as to add concealment of devices such as a printed circuit board below the light cover 100. However, the region of the rough surface can be located on any part of the light cover 100 except the asymmetric lenses 120 and changed according to practical requirements. In addition, the rough front surface 110a may be formed by specific surface textures built into a die of the molding process. In addition, a rear surface of the substrate 110 may be screened or colored for concealment purposes as well.

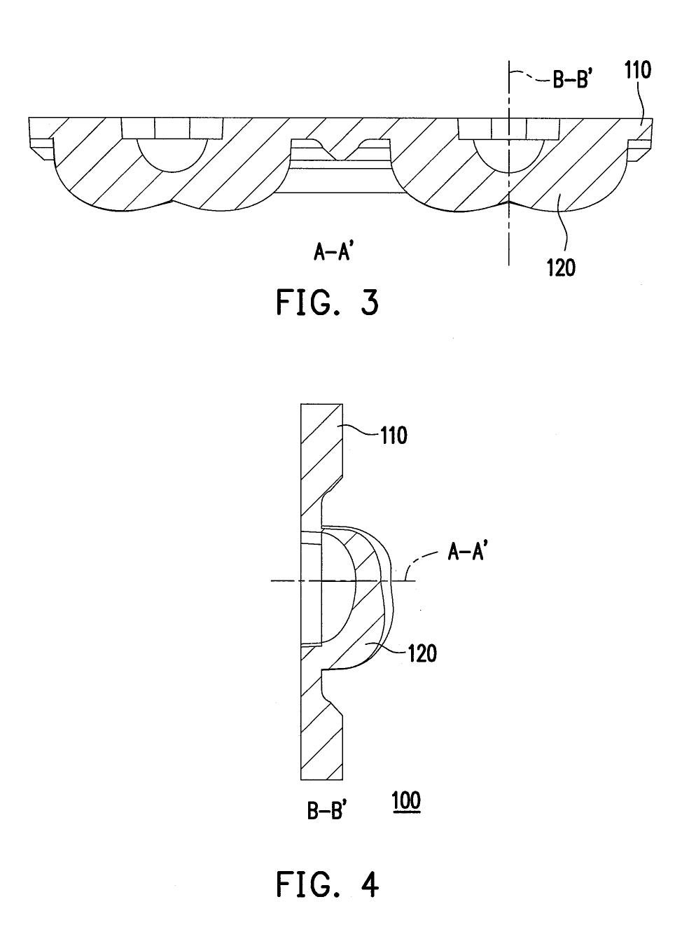

In the present embodiment, a profile of the light cover 100 along a cross-section A-A′ in FIG. 2 is illustrated in FIG. 3. Another profile of the light cover 100 along a cross-section B-B′ in FIG. 2 is illustrated in FIG. 4. The cross-section A-A′ and the cross-section B-B′ are perpendicular to each other. As shown in FIG. 3, the profile of the asymmetric lens 120 along the cross-section A-A′ is symmetric with respect to the cross-section B-B′; while as shown in FIG. 4, the profile of the asymmetric lens 120 along the cross-section B-B′ is asymmetric with respect to the cross-section A-A′.

Referring to FIG. 2, the asymmetric lenses 120 are oriented in a same direction to provide a uniform planar illumination. In the present embodiment, the substrate 110 has a longitudinal axis 114 and the cross-section B-B′ of each of the asymmetric lenses 120 is parallel to the longitudinal axis 114. Each of the asymmetric lenses 120 is adapted to receive a light and transform the light into an asymmetric light output.

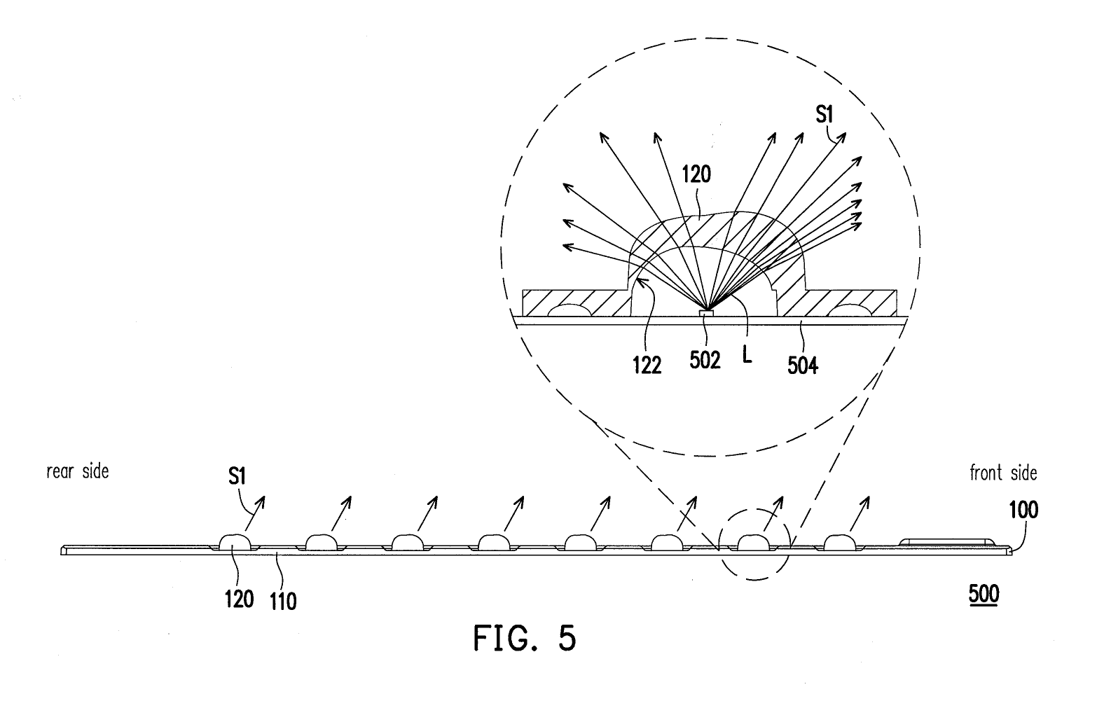

More specifically, the aforementioned light cover 100 may be accompanied with a light source to form an illuminating apparatus. FIG. 5 is a side view of an illuminating apparatus accompanied with an enlarged cross-sectional view of the asymmetric lens 120 in FIG. 4 according to an embodiment of the present invention. Referring to FIG. 5, the illuminating apparatus 500 comprises a plurality of light sources 502 and the light cover 100 as mentioned in the above embodiment. Herein, each of the light sources 502 may be a light emitting diode or other applicable light sources. The light sources 502 are disposed corresponding to the asymmetric lenses 120 of the light cover 100. Each of the asymmetric lenses 120 has a light incident surface 122 which is concaved for accommodating the corresponding light source 502 and receiving lights L emitted from the light source 502.

Furthermore, the light sources 502 may be carried by a printed circuit board (PCB) 504. Practically, the light sources 502 may be soldered via SMD process onto the PCB 504. The light cover 100 is prealigned with the PCB 504 via mounting holes 180 (shown in FIG. 1) on the light cover 100. All devices are precisely placed and the light cover 100 can further be screwed onto to the PCB 504. There may or may not be an adhesive layer such as silicone or an adhesive tape between the light cover 100 and the PCB 504.

Each of the asymmetric lenses 120 receives the lights L emitted from the corresponding light source 502 and transforms the lights L into an asymmetric light output. In the present embodiment, the major light output S1 from each of the lenses 120 tends to a front side of the illuminating apparatus 500, and thereby the illuminating intensity at the front side of the illuminating apparatus 500 is greater than the illuminating intensity at other sides of the illuminating apparatus 500. Furthermore, a sidewall of, the recess 112 (shown in FIG. 1) is capable of scattering large-angle lights emitted from the light source 502.

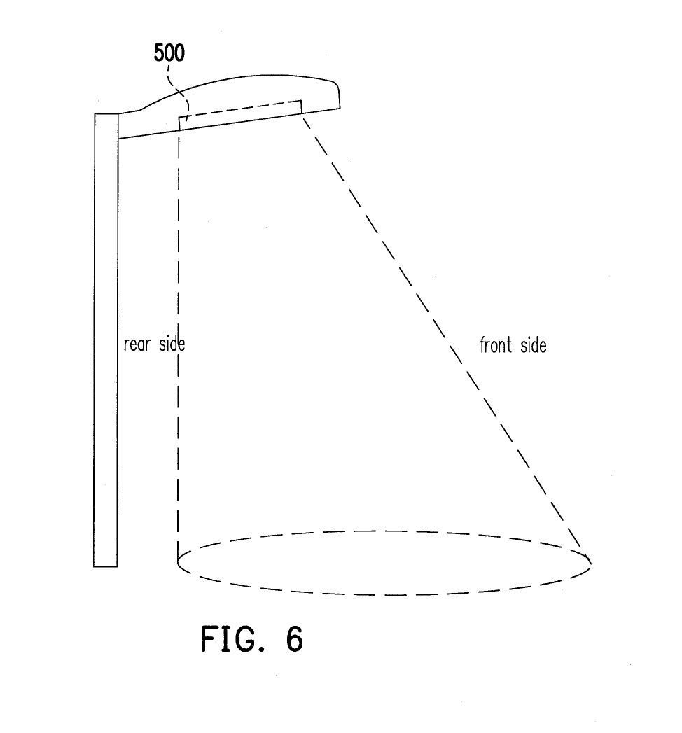

As applying the aforementioned illuminating apparatus 500 to a streetlamp 600 as shown in FIG. 6, the light output at the rear side of the streetlamp 600 is reduced, the light output at the front side of the streetlamp 600 is accordingly enhanced, and thus a more concentrated illuminating area can be obtained at the front side of the streetlamp 600.

The illuminating apparatus 500 adopts the asymmetric lenses to receive the lights L emitted from the light sources 502 and transform the lights L in to an asymmetric light output for a specific illuminating requirement. However, it is noted that the profile of the asymmetric lenses 120 are not limited to those as illustrated in FIGS. 1-5. Different profiles of light output can be obtained by changing the position of the light source relative to the corresponding asymmetric lens and varying the profile of the lens, such as the contour of a light emergent surface and a light incident surface of the lens, and the lens thickness, etc., to meet various illuminating requirements.

Furthermore, the orientation of the asymmetric lenses can be changed to adjust the direction of the major light output of the illuminating apparatus.

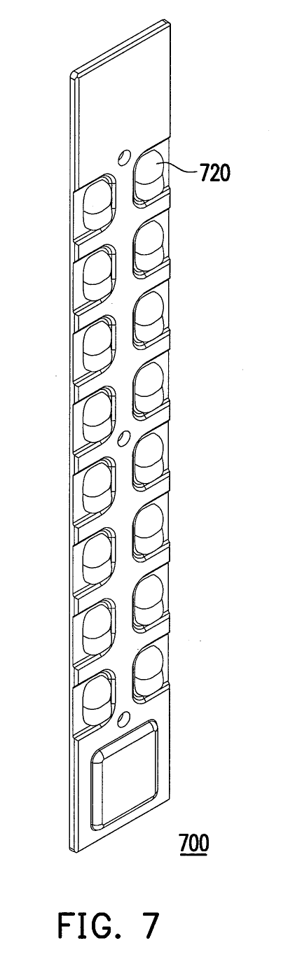

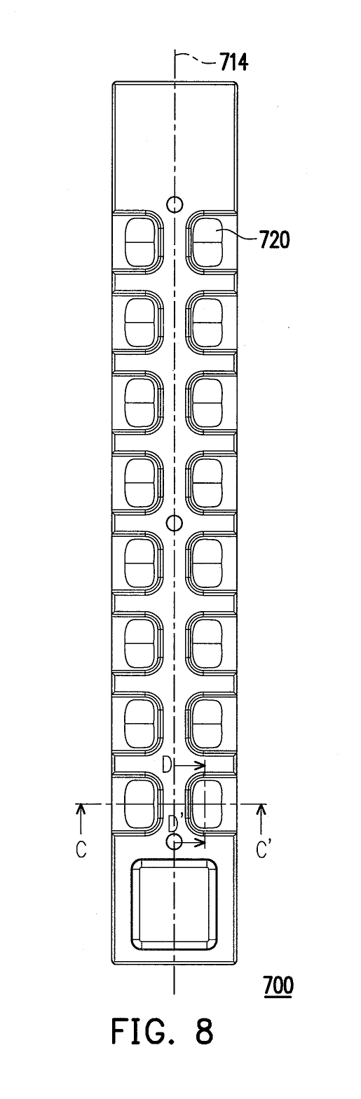

FIG. 7 illustrates a light cover according to another embodiment of the present invention. FIG. 8 is a front view of the light cover of FIG. 7. The light cover 700 of the present embodiment is similar to the light cover 100 of the previous embodiment except that the orientation of the asymmetric lenses 720 of the light cover 700 of the present embodiment is perpendicular to that of the asymmetric lenses 120 of the light cover 100 of the previous embodiment.

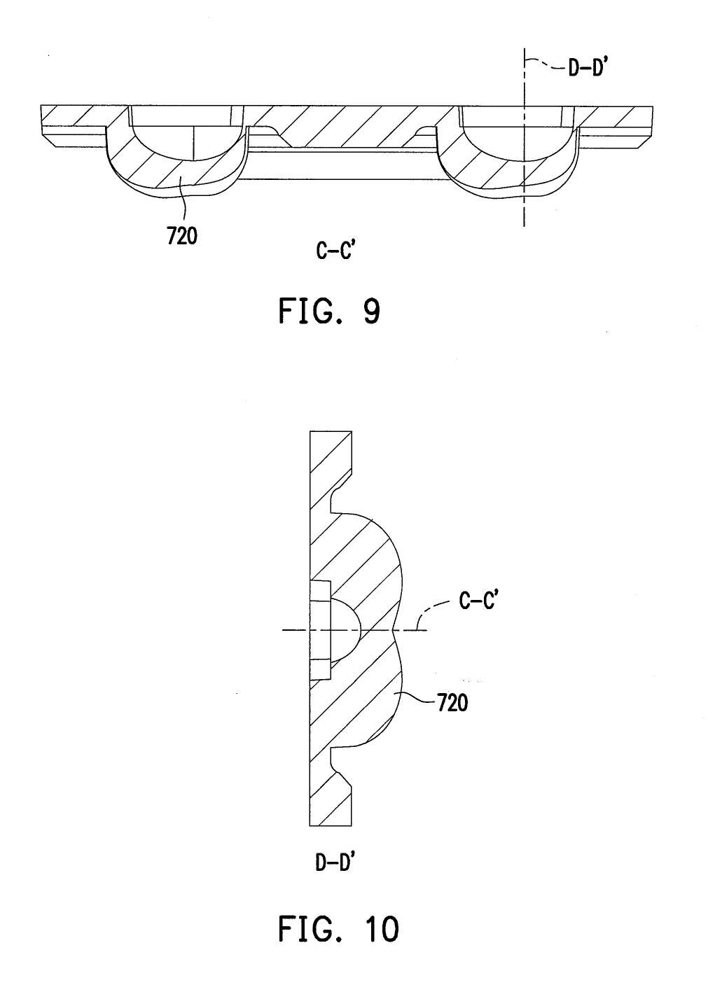

More specifically, a profile of the light cover 700 along a cross-section C-C′ in FIG. 8 is illustrated in FIG. 9. Another profile of the light cover 700 along a cross-section D-D′ in FIG. 8 is illustrated in FIG. 10. The cross-section C-C′ and the cross-section D-D′ are perpendicular to each other. Referring to FIG. 9, the profile of the asymmetric lens 720 along the cross-section C-C′ is asymmetric with respect to the cross-section D-D′; while as shown in FIG. 10, the profile of the asymmetric lens 720 along the cross-section D-D′ is symmetric with respect to the cross-section C-C′. Actually, the profile of the asymmetric lens 720 of the present embodiment is identical to the profile of the asymmetric lens 120 of the previous embodiment. Furthermore, the substrate 710 has a longitudinal axis 714 and the cross-section C-C′ of each of the asymmetric lenses 720 is perpendicular to the longitudinal axis 714.

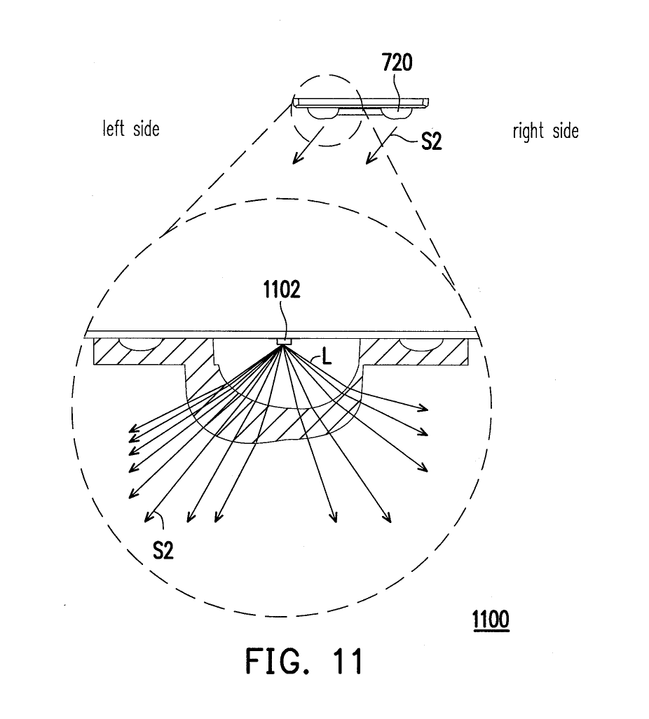

FIG. 11 is a side view of an illuminating apparatus accompanied with an enlarged cross-sectional view of the asymmetric lens 720 in FIG. 9 according to an embodiment of the present invention. Each of the asymmetric lenses 720 is adapted to receive lights L emitted from the corresponding light source 1102 and transform the lights L into an asymmetric light output. In the present embodiment, the major light output S2 from each of the asymmetric lenses 720 tends to a left side of the illuminating apparatus 1100, and thereby the illuminating intensity at the left side of the illuminating apparatus 1100 is greater than the illuminating intensity at other sides of the illuminating apparatus 1100. Similarly to the previous embodiment, a sidewall of a recess is capable of scattering large-angle lights emitted from the light source 1102.

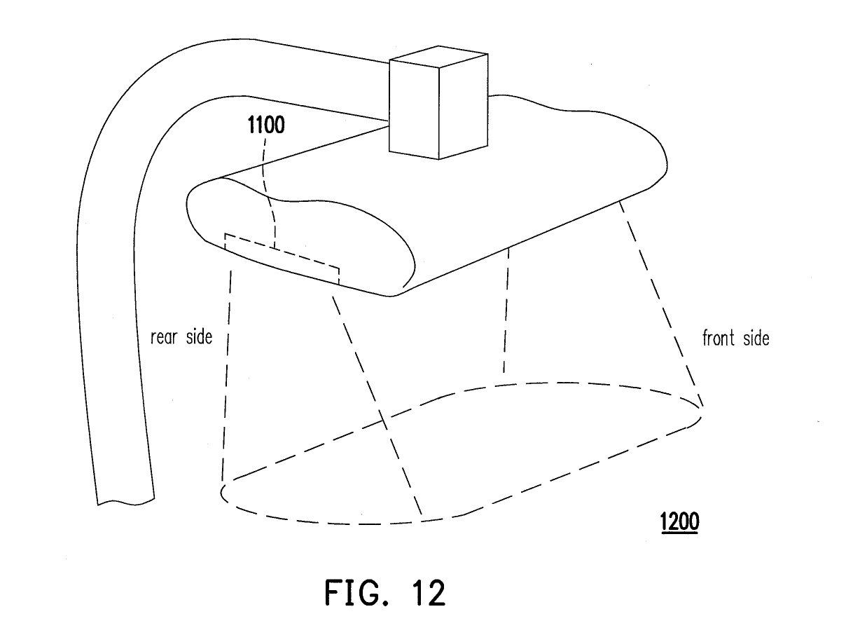

As applying the aforementioned illuminating apparatus 1100 to a streetlamp 1200 as shown in FIG. 12, the light output at the rear side (corresponding to the right side of the illuminating apparatus 1100 in FIG. 11) of the streetlamp 1200 is reduced, the light output at the front side (corresponding to the left side of the illuminating apparatus 1100 in FIG. 11) of the streetlamp 1200 is accordingly enhanced, and thus a more concentrated illuminating area can be obtained at the front side of the streetlamp 1200.

The above embodiments disclose light covers adopting asymmetric lenses. However, the lenses adopted in the present application can be symmetric lens, depending on the light cover's usage.

In summary, the light cover of the present invention adopts lenses having unique profiles for providing a unique, predefined light output profile. By utilizing the lenses, the profile of light output of an illuminating apparatus applying the light cover can be adjusted to meet various illuminating requirements, and the availability of the illuminating apparatus can therefore be improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An illuminating apparatus, comprising:
a light cover, comprising:
a substrate provided with a plurality of recesses on a front surface; and
a plurality of lenses integrated with the substrate and respectively located in the recesses, the lenses being oriented in a same direction; and
a plurality of light sources disposed corresponding to the lenses, wherein each of the light sources is adapted to emit a light and each of the lenses is adapted to receive the light and transform the light into a light output.

2. The illuminating apparatus according to claim 1, wherein the lens is an asymmetric lens to transform the light into an asymmetric light output.

3. The illuminating apparatus according to claim 2, wherein each of the asymmetric lenses has a first profile along a first cross-section and a second profile along a second cross-section perpendicular to the first cross-section, the first profile is asymmetric with respect to the second cross-section, and the second profile is symmetric with respect to the first cross-section.

4. The illuminating apparatus according to claim 3, wherein the substrate has a longitudinal axis and the second cross-section of each of the asymmetric lenses is parallel to the longitudinal axis.

5. The illuminating apparatus according to claim 3, wherein the substrate has a longitudinal axis and the second cross-section of each of the asymmetric lenses is perpendicular to the longitudinal axis.

6. The illuminating apparatus according to claim 1, wherein the lenses are arranged in an array.

7. The illuminating apparatus according to claim 1, wherein the front surface of the substrate is a rough surface.

8. The illuminating apparatus according to claim 1, wherein each of the lenses has a light incident surface which is concaved for accommodating the corresponding light source and receiving the light emitted from the light source.

9. The illuminating apparatus according to claim 1, wherein the lenses and the substrate are integrally formed as one piece.

10. The illuminating apparatus according to claim 1, wherein each of the light sources comprises a light emitting diode.

11. The illuminating apparatus according to claim 10, further comprising a printed circuit board carrying the light emitting diodes.

12. A light cover, comprising:
a substrate provided with a plurality of recesses on a front surface; and
a plurality of lenses integrated with the substrate and respectively located in the recesses, the lenses being oriented in a same direction, wherein each of the lenses is adapted to receive a light and transform the light into a light output.

13. The light cover according to claim 12, wherein the lens is an asymmetric lens to transform the light into an asymmetric light output.

14. The light cover according to claim 13, wherein each of the asymmetric lenses has a first profile along a first cross-section and a second profile along a second cross-section perpendicular to the first cross-section, the first profile is asymmetric with respect to the second cross-section, and the second profile is symmetric with respect to the first cross-section.

15. The light cover according to claim 14, wherein the substrate has a longitudinal axis and the second cross-section of each of the asymmetric lenses is parallel to the longitudinal axis.

16. The light cover according to claim 14, wherein the substrate has a longitudinal axis and the second cross-section of each of the asymmetric lenses is perpendicular to the longitudinal axis.

17. The light cover according to claim 12, wherein the lenses are arranged in an array.

18. The light cover according to claim 12, wherein the front surface of the substrate is a rough surface.

19. The light cover according to claim 12, wherein each of the lenses has a light incident surface which is concaved for accommodating a light source and receiving the light emitted from the light source.

20. The light cover according to claim 12, wherein the lenses and the substrate are integrally formed as one piece.
